(19) United States
(12) Patent Application Publication
(10) Pub. No.: US 2017/0362991 A1
(43) Pub. Date: Dec. 21, 2017

(54) HOUSING CONNECTION

(71) Applicant: TENNECO GMBH, Edenkoben (DE)

(72) Inventors: Peter Schneider, Hollfeld (DE); Frank Kimmel, Landau (DE); Andreas Holweg, Offenbach (DE); Sébastien Sarter, Minversheim (FR); Ralf Waldschmitt, Edenkoben (DE)

(21) Appl. No.: 15/626,480

(22) Filed: Jun. 19, 2017

(30) Foreign Application Priority Data
Jun. 21, 2016 (DE) 10 2016 111 336.0

(51) Int. Cl. F01N 13/18; F16L 3/237

(52) U.S. Cl. CPC F01N 13/1805; F16L 3/237

(57) ABSTRACT

A housing connection for connecting at least two adjacently placed exhaust gas housing end sections or exhaust pipe end sections of an exhaust gas housing or exhaust pipe, wherein the housing connection includes a spacer element which can be introduced between the two end sections, and wherein at least one retaining part is provided, configured as a retaining band, with at least two ends, which can be applied onto a circular shape of the exhaust gas housing or exhaust pipe end sections which are to be connected, and which at least partially circumferentially surrounds the respective end section, wherein the respective end is secured to the spacer element, and wherein the spacer element can be brought into contact against the respective exhaust gas housing end section or exhaust pipe end section, at least indirectly by way of the retaining band, or directly.

### FIELD OF THE INVENTION

The invention relates to a housing connection for connecting at least two adjacently placed exhaust gas housing end sections or exhaust pipe end sections of at least one exhaust gas housing or exhaust pipe, wherein the housing connection comprises a spacer element which can be introduced between the two end sections, and wherein at least one retaining part is provided, configured as a retaining band, with at least two ends, which can be applied onto a circular shape of the end sections of the exhaust gas housing or exhaust pipe which are to be connected, and which at least partially circumferentially surrounds the respective end section. The exhaust gas housing end sections or exhaust pipe end sections are arranged next to one another or adjacent to one another, irrespective of the course of the respective mid-axis or longitudinal axis respectively of the further exhaust gas housing or exhaust pipe.

### BACKGROUND OF THE INVENTION

A pipe manifold is already known from FR 2 612 252 A1 which serves to connect manifold pipes. The pipe manifold comprises an inner part and an outer part. The inner part is arranged between the pipes, and serves as a spacer element. The outer part is formed by the tubular end piece, and accommodates the inner part with the pipe ends.

From JP S60 120 218 U a housing connection is known with a spacer element and a retaining band, wherein the spacer element is arranged at a distance interval from the exhaust gas housing.

### SUMMARY OF THE INVENTION

The invention is based on the object of forming and arranging a housing connection in such a way that an adaption to different design forms and a space-saving structural arrangement are ensured.

The object is solved according to the invention in that the spacer element can be located at least indirectly by means of the retaining band or directly against the respective exhaust gas housing end section or exhaust pipe end section. The retaining band comprises at least two ends, wherein the respective end is secured or welded indirectly or directly to the spacer element. In this way, on the one hand the situation is achieved that, by the use of a retaining band or of a plurality of retaining bands of one size or length, different housing connections for exhaust gas housing end sections or exhaust pipe end sections can be configured with different diameters. It is also possible for different spacer elements to be used, such that different spacing intervals between the end sections are possible with retaining bands of one length. The retaining band or its ends respectively ensure a variable overlapping of retaining band and spacer element, for the purpose of adjusting to the pipe diameter on the one hand and to the pipe interval spacing on the other. With a single-piece retaining band, only two ends need to be connected with the spacer element. On the other sections of the retaining band, the retaining band is connected or welded to the spacer element either by the side surface or the underside, or welded through by way of the upper side. A function separation takes place. By means of the spacer element, the spacing interval between the exhaust gas housings is defined, while the length of the retaining band has no influence on the spacing interval of the exhaust gas housings which are to be connected.

It can also be advantageous in this situation if the retaining band is configured as of two parts, and a first band part exhibits two ends and a second band part exhibits two ends, wherein the respective ends of each band part are secured indirectly or directly to the spacer element. The band part and the spacer element are in this situation preferably materially bonded, such as by welding or hard soldering.

In addition, it can be advantageous in this situation if the spacer element comprises four coupling zones K1, K2, K3, K4, in which the respective end of the retaining band can be connected to the spacer element, wherein the four coupling zones K1, K2, K3, K4 are offset, in relation to the circular shape of the retaining band by an angle α, with 20°≦α≦180° or 70°≦α≦150° or α=120°. The offset of the coupling zones K1, K2, K3, K4 ensures a simple and adequate securing of the retaining band and of the exhaust gas housing which is to be connected.

It can further be of advantage if the spacer element comprises at least two circular contact sections, and a web which connects the contact sections, wherein the contact sections can at least partly be brought into contact against the respective round exhaust gas housing end section or exhaust pipe end section. Both contact sections, thanks to the circular and concomitantly adapted shape, ensure a secure and adequate support for the exhaust gas housing which is to be connected. Each circular contact section can have one or a plurality of contact zones.

In this situation it can also be of advantage if the respective contact section extends, in relation to the circular shape of the retaining band, over an angle α, with 20°≦α≦180° or 70°≦α≦150° or α=120°. The extension over the angle α ensures a secure support for the exhaust gas housing which is to be connected, in particular for installation purposes.

The retaining band can also be configured as at least partially offset, but is preferably flat or for the most part flat. Due to this band-shaped formation, simple surrounding or gripping of the respective exhaust pipe end section is possible. As well as this, the relative position with regard to the spacer element can be individually selected.

It can also be advantageous if the retaining band is arranged at least partially above or below the spacer element or between the spacer element and the exhaust pipe end section, or if the retaining band and the spacer element are butt-jointed. In the latter case, the retaining band is placed with the respective end placed in sandwich fashion between the spacer element and the exhaust pipe end section. The retaining band can, as an alternative, also be placed above the spacer element, concomitantly placed outside, or butt-jointed against the spacer element. The overlapping has the advantage that an individual shortening of the retaining band is not necessary. The resulting projection of the retaining band projects in the region of the spacer element either inside the spacer element or outside the spacer element. If the retaining band projects, in the region of the spacer element, outside the spacer element, then a through-welding of the exhaust pipe end section on the inside is possible. With the butt-jointed arrangement, while it is true that a more precise matching of the length of the retaining band is necessary, this nevertheless makes through-welding possible, without further ado, both on the inside as well as on the outside.

In this situation it can advantageously be provided that the spacer element is indeed preferably of one part, but it can also be configured as multi-part, or for a plurality of spacer elements to be provided. Different spacer elements can be combined, depending on the arrangement of the exhaust pipe end sections which are to be connected.

Also advantageous is a system consisting of at least one housing connection as described heretofore, and a plurality of exhaust gas housings or exhaust pipes, wherein the exhaust gas housings or exhaust pipes are connected by way of the housing connection. By the use of this housing connection according to the invention, exhaust gas housings or exhaust pipes can be connected accordingly. A restriction to the respective end section is not necessary.

In this situation it can be advantageous if the retaining band is arranged in sandwich fashion at least partially between the spacer element and the exhaust gas housing, or if at least the coupling zones K1, K2, K3, K4 of the spacer element are arranged in sandwich fashion between the retaining band and the exhaust gas housing. Both variants are possible. The determinant factor is the arrangement of the coupling zones K1, K2, K3, K4. The variant first referred to is applicable if the insertion of the retaining band between the spacer element and the exhaust gas housing is possible; otherwise, the retaining band is laid onto the spacer element.

It can further be advantageous if at least two, three, four, or five exhaust gas housings or exhaust pipes are provided, which are brought into contact with one another indirectly by means of at least one spacer element and are connected, indirectly or directly, by means of at least one retaining band or a plurality of band parts.

### BRIEF DESCRIPTION OF THE DRAWINGS

Further advantages and features of the invention are explained in the claims and in the description and represented in the figures. The figures show:

FIG. 1 a principle sketch of two exhaust gas housings connected by a retaining band;

FIG. 2 the arrangement according to FIG. 1;

FIG. 3 the arrangement according to FIG. 1 in a view from above;

FIG. 4 a principle sketch of the cross-section Q of the retaining band;

FIG. 5 a principle sketch in a side view;

FIG. 6 a principle sketch in a side view with three exhaust gas housings; and

FIG. 7 the arrangement according to FIG. 5.

### DETAILED DESCRIPTION OF THE INVENTION

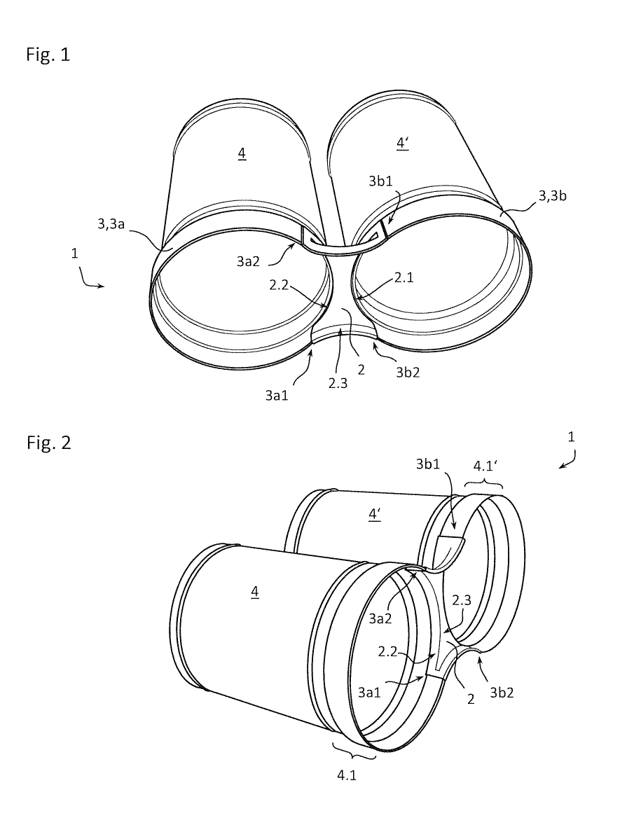

According to FIG. 1, two exhaust gas housings 4, 4′ or exhaust pipes 4, 4′ respectively are positioned relative to one another by means of a spacer element 2, and connected by means of a two-part retaining band 3, and concomitantly by a first band part 3a and a second band part 3b to the spacer element 2. The spacer element 2 is arranged in this situation in the region of the respective exhaust gas housing end section or exhaust pipe end section 4.1, 4.1′ as also represented according to FIG. 2. For this purpose, the spacer element 2 comprises at least two circular contact sections 2.1, 2.2, and a web 2.3, which connects the contact sections 2.1, 2.2. The contact sections 2.1, 2.2 lie at least indirectly against the respective exhaust gas housing end section or exhaust pipe end section 4.1, 4.1′ for support. The spacer element 2 comprises four coupling zones K1, K2, K3, K4, in which the respective end 3a1, 3a2, 3b1, 3b2 of the retaining band 3 is connected or welded to the spacer element 2. The four coupling zones K1, K2, K3, K4 are offset in relation to the circular shape of the retaining band 3 by an angle α of some 120°. In a corresponding manner, the respective contact section 2.1, 2.2 extends with respect to the circular shape of the retaining band 3 likewise by an angle α of some 120°. The web 2.3 extends in a radial direction between both contact sections 2.1, 2.2. At both the ends, the web 2.3 is bent over forwards and extends in the axial direction.

The respective band part 3a, 3b runs in this situation circumferentially around the respective exhaust pipe 4, 4′ or the respective end section 4.1, 4.1′ and ends in the region of the respective coupling zone K1, K2, K3, K4 of the spacer element 2. Accordingly, the respective end 3a1, 3a2, 3b1, 3b2 is placed in the region of the spacer element 2. In this situation, the respective end 3a1-3b2 can be placed in sandwich fashion between the spacer element 2 and the respective end section 4.1, 4.1′, or alternatively placed outside, such that the respective part of the spacer element 2 is placed between the respective end 3a1-3b2 and the respective end section 4.1, 4.1′ in sandwich fashion. As an alternative to these two variants, the respective end 3a1-3b2 can also be positioned butt-jointed against the spacer element 2 or a respective spacer element part 2a, 2b.

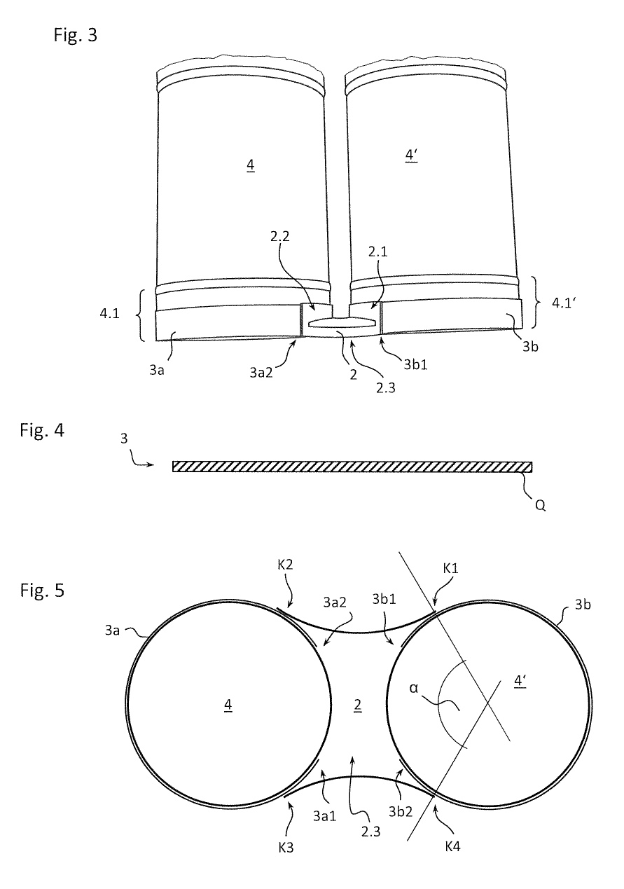

According to FIGS. 1 to 3, the respective end 3a1-3b2 of the retaining band 3 is butt-jointed against the spacer element 2.

As represented according to FIG. 4, the retaining band 3 exhibits a flat cross-section profile Q, such that this can be wound circumferentially over the respective end section 4.1, 4.1′.

In the principle sketch according to FIG. 5, as an alternative, all the ends 3a1-3b2 of the two band parts 3a, 3b are placed in sandwich fashion between the respective exhaust pipe 4, 4′ and the spacer element 2. The respective contact sections 2.1, 2.2 in this case are in contact, at least partially only indirectly, by way of the ends 3a1-3b2 against the respective exhaust gas housing end section or exhaust pipe end section 4.1, 4.1′. Between the four coupling zones K1, K2, K3, K4, the respective contact section 2.1, 2.2 is preferably directly in contact against the respective exhaust gas housing end section or exhaust pipe end section 4.1, 4.1′. The projections or ends 3a1-3b2 of the respective band part 3a, 3b, remaining in the interior in the region of the spacer element 2, are derived individually on the basis of the sizes or tolerances present in relation to the diameters of the exhaust pipes 4, 4′ on the one hand, and the length of the respective band part 3a, 3b on the other.

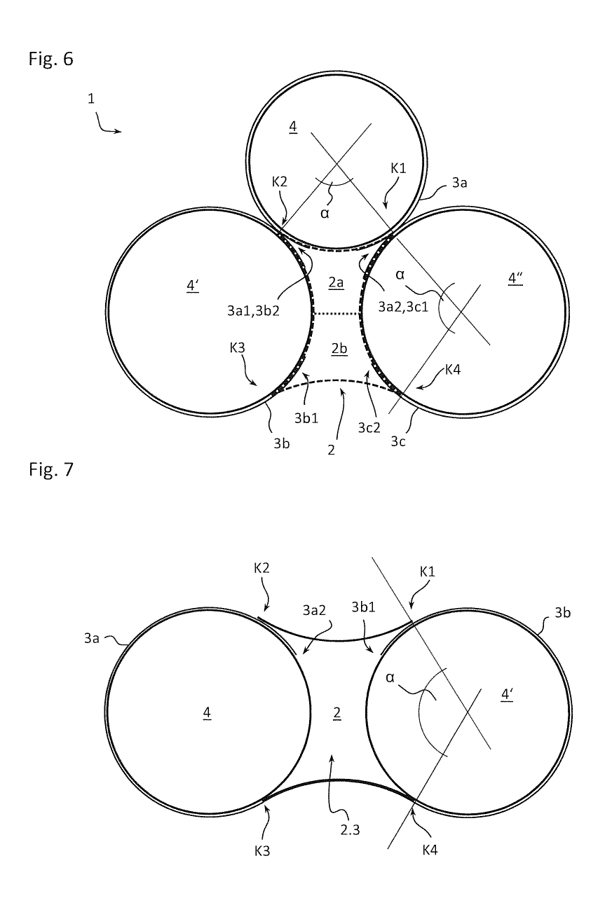

In the embodiment according to FIG. 6, the spacer element 2 is configured as two-part and comprises two spacer element parts 2a, 2b, which in combination ensure the relative position of the exhaust pipe end sections 4.1, 4.1′ or of the exhaust gas housings 4, 4′, 4″. The respective ends 3a1-3c2 of the band parts 3a, 3b, 3c project in the interior of the spacer element 2, such that the spacer element 2 is placed in the region of the respective end 3a1-3c2 in sandwich fashion between the respective band part 3a-3c and the respective exhaust pipe 4-4″.

For the purpose of the materially-bonded connection, the respective exhaust pipe end section 4.1, 4.1′ and the respective band part 3a-3c, as well as the spacer element 2, are preferably welded on the pipe inner side. For this purpose, a weld seam is arranged circumferentially over the circumference, which connects the adjacent component parts by a material bond. The weld seam can of course also be arranged on the outside, running over the circumference, wherein the narrow point between the two exhaust gas housings 4, 4′, 4″ represents a problem point for this welding process. The two coupling zones K1, K4 are offset in relation to the circular shape of the retaining band 3 by an angle α of some 115°. The two coupling zones K1, K2 are offset in relation to the circular shape of the retaining band 3 by an angle α of some 80°.

According to the embodiments in FIG. 1 to FIG. 3, the retaining band 3 or the respective band part 3a-3b project in the axial direction over the end of the respective exhaust gas housing or exhaust pipe 4, 4′. This also applies to the spacer element 2. The form and size of this projection can be freely selected depending on the application situation. A projection also favours the use of an interior weld seam. If it is intended that the weld seam should be arranged on the outside, this projection is not necessary for this purpose.

In an embodiment which is not represented, the respective exhaust gas housings 4, 4′ can also be coupled in the region of both end sections by means of a corresponding housing connection.

In the embodiment according to FIG. 7, a single-part retaining band 3 is provided. Only the two ends 3a2, 3b1 are connected by the spacer element 2. On the other sections of the retaining band 3, in particular opposite the two ends 3a2, 3b1, the retaining band is connected or welded to the spacer element 2 either by the side surface or the underside, or through-welded via the outside.

### REFERENCE NUMBER LIST

1 Housing connection
2 Spacer element
2.1 Contact section
2.2 Contact section
2.3 Web
2a Spacer element part
2b Spacer element part
3 Retaining part, retaining band
3a First band part
3b Second band part
3c Third band part
3a1 End
3a2 End
3b1 End
3b2 End
3c1 End
3c2 End
4 Exhaust gas housing or exhaust pipe
4′ Exhaust gas housing or exhaust pipe
4″ Exhaust gas housing or exhaust pipe
4.1 Exhaust gas housing- or exhaust pipe end section
4.1′ Exhaust gas housing- or exhaust pipe end section
K1 Coupling zone
K2 Coupling zone
K3 Coupling zone
K4 Coupling zone
Q Cross-section profile
α Angle

What is claimed is:

1. A housing connection for connecting at least two adjacently placed exhaust gas housing end sections or exhaust pipe end sections of an exhaust gas housing or exhaust pipe, wherein the housing connection comprises:
a spacer element which can be introduced between the two end sections, wherein at least one retaining part is provided, configured as a retaining band, with at least two ends, which can be introduced onto a circular shape of the exhaust gas housing end section or exhaust pipe end section which is to be connected and at least partially surrounds the respective end section circumferentially, wherein the respective end is secured to the spacer element, wherein the spacer element can be brought into contact against the respective exhaust gas housing end section or exhaust pipe end section, at least indirectly by way of the retaining band or directly.

2. The housing connection according to claim 1, wherein the retaining band is configured as two-part, and comprises a first band part with two ends and a second band part with two ends, wherein the respective ends of each band part are connected to the spacer element.

3. The housing connection according to claim 1, wherein the spacer element comprises four coupling zones K1, K2, K3, K4, in which the respective end of the retaining band can be connected to the spacer element, wherein the four coupling zones K1, K2, K3, K4 are offset in relation to the circular shape of the retaining band by an angle α, with 20°≦α≦180° or α=120°.

4. The housing connection according to claim 2, wherein characterized in that the spacer element comprises at least two circular contact sections, as well as a web which connects the contact sections, wherein the contact sections can be brought into contact against the respective circular exhaust gas housing end section or exhaust pipe end section.

5. The housing connection according to claim 4, wherein the respective contact section extends in relation to the circular shape of the retaining band over an angle α, with 20°≦α≦180° or α=120°.

6. The housing connection according to claim 1, wherein the retaining band is arranged at least partially below or above the spacer element, or that the retaining band and the spacer element are butt-jointed.

7. The housing connection according to claim 1, wherein the spacer element is configured as multi-part, or that a plurality of spacer element parts are provided.

8. A system, consisting of: the housing connection according to claim 1 and a plurality of exhaust gas housings or exhaust pipes, wherein the exhaust gas housings or exhaust pipes are connected by the housing connection.

9. The system according to claim 8, wherein the retaining band is arranged at least partially between the spacer element and the exhaust gas housing in sandwich fashion, or that at least coupling zones K1, K2, K3, K4 of the spacer element are arranged between the retaining band and the exhaust gas housing in sandwich fashion.

10. The system according to claim 8, wherein two, three, four, or five exhaust gas housings or exhaust pipes are provided, which are brought into contact against one another by means of at least one spacer element part, and are connected by at least one retaining band or a plurality of band parts.

11. The housing connection according to claim 2, wherein the spacer element comprises four coupling zones K1, K2, K3, K4, in which the respective end of the retaining band can be connected to the spacer element, wherein the four coupling zones K1, K2, K3, K4 are offset in relation to the circular shape of the retaining band by an angle α, with 20°<_α<_180° or α=120°.

12. The housing connection according to claim 11, wherein characterized in that the spacer element comprises at least two circular contact sections, as well as a web which connects the contact sections, wherein the contact sections can be brought into contact against the respective circular exhaust gas housing end section or exhaust pipe end section.

13. The housing connection according to claim 12, wherein the respective contact section extends in relation to the circular shape of the retaining band over an angle α, with 20°≦α≦180° or α=120°.

14. The housing connection according to claim 13, wherein the retaining band is arranged at least partially below or above the spacer element, or that the retaining band and the spacer element are butt-jointed.

15. The housing connection according to claim 14, wherein the spacer element is configured as multi-part, or that a plurality of spacer element parts are provided.

16. The system according to claim 9, wherein two, three, four, or five exhaust gas housings or exhaust pipes are provided, which are brought into contact against one another by means of at least one spacer element part, and are connected by at least one retaining band or a plurality of band parts.

17. A system, consisting of: the housing connection according to claim 15, and a plurality of exhaust gas housings or exhaust pipes, wherein the exhaust gas housings or exhaust pipes are connected by the housing connection.
